(19) United States
(12) Patent Application Publication
(10) Pub. No.: US 2009/0173762 A1
(43) Pub. Date: Jul. 9, 2009

(54) Detachable Fastening Apparatus

(76) Inventors: Kun-Chieh Wang, Taichung City (TW); Jung-Chin Liang, Chang Hua City (TW); David Tsai, Chang Hua City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/404,390

(22) Filed: Mar. 16, 2009

Related U.S. Application Data
(63) Continuation-in-part of application No. 10/908,451, filed on May 12, 2005.

(51) Int. Cl. B60R 9/00

(52) U.S. Cl. 224/402

(57) ABSTRACT

A detachable fastening apparatus comprises a base member including a first end adapted for coupling to a truck and a second end being able to be tied by a rope; and a pivot plate member, which is moveable between a first position and a second position, pivotally coupled to the base member between the first and second ends of the base member and selectively positioned in the first position or the second position via a positioning member.

### CROSS REFERENCE TO RELATED PATENT APPLICATION

This application is a continuation-in-part application of application Ser. No. 10/908,451, filed May 12, 2005, the contents of which are incorporated herein by reference.

### BACKGROUND OF THE INVENTION

1. Field of the Invention

The present invention relates to a detachable fastening apparatus.

2. Description of the Related Art

As claimed in Taiwanese Patent No. M282869, an apparatus used for truck includes a base, a positioning member and a fastening unit. The base has a coupled portion which is groove-shaped and the fastening unit has a fixed portion engaged with the coupled portion of the base. A cooperation of the coupled portion and the fixed portion prevents the fastening unit detaching from the base. However, a loading which the apparatus has to bear could be large, and it might be not stable enough to fix the fastening unit with respect to the base in position. Further, the fastening unit is positioned to the base in a stationary angle only. The present invention is therefore intended to obviate or at least alleviate the problems encountered in prior art.

### SUMMARY OF THE INVENTION

Aspects of the present invention address one or more of the issues mentioned above, thereby providing a detachable fastening apparatus adapted for fastening goods to a truck. The fastener apparatus includes a base member, a pivot plate member and a positioning member used for pivoting the pivot plate member with respect to the base member. The pivot plate member is moveable between a first position and a second position. While the pivot plate member is the first position, the fastening apparatus is used for fastening a bicycle to the truck. While the pivot plate member is in the second position, the fastening apparatus is used for tying goods to the truck.

Other objectives, advantages, and features of the invention will become more apparent from the following detailed description when taken in conjunction with the accompanying drawings.

### BRIEF DESCRIPTION OF THE DRAWINGS

The present invention will be described via detailed illustration of the preferred embodiment referring to the drawings.

FIG. 1 is a perspective view of a fastening apparatus according to the preferred embodiment of the present invention.

FIG. 2 is an exploded view of the fastening apparatus shown in FIG. 1.

FIG. 3 is another exploded, perspective view of the fastening apparatus shown in FIG. 1.

FIG. 4 is a cross-sectional view taken along 4-4 in FIG. 1.

FIG. 5 is a cross-sectional view taken along 5-5 in FIG. 4.

FIG. 6 is another cross-sectional view similar to FIG. 4.

FIG. 7 is another cross-sectional view similar to FIG. 5.

FIG. 8 is another cross-sectional view similar to FIG. 7.

FIG. 9 is a perspective view of the fastening apparatus shown in FIG. 1 and used for tying goods to a truck.

FIG. 10 is a partial, enlarged view of the fastening apparatus shown in FIG. 9.

FIG. 11 is a perspective view of the fastening apparatus shown in FIG. 1 and used for fastening a bicycle to a truck.

FIG. 12 is a partial, enlarged view of the fastening apparatus shown in FIG. 11.

### DETAILED DESCRIPTION OF THE PREFERRED EMBODIMENT

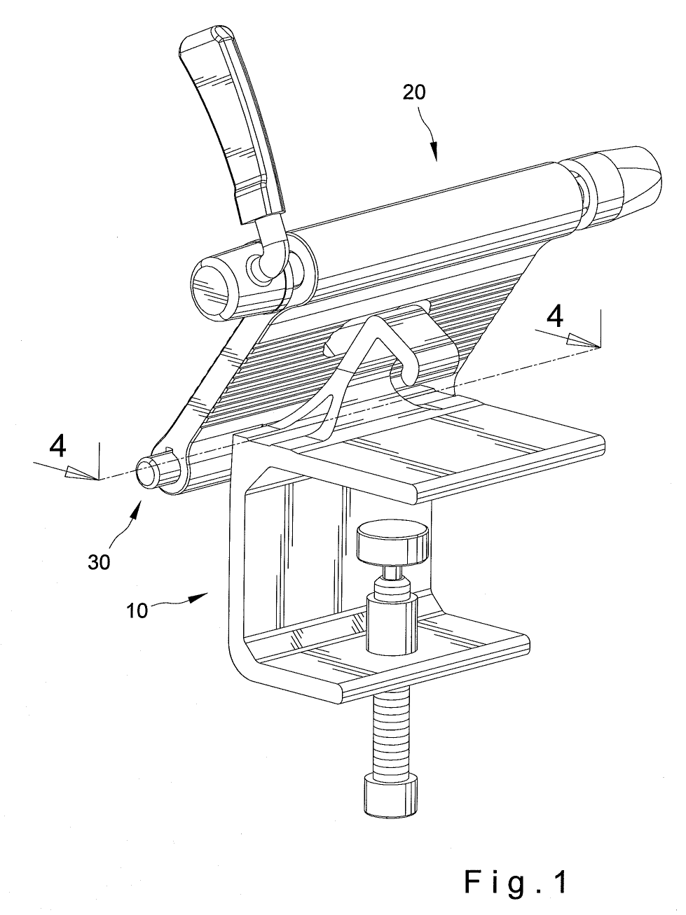

Referring to FIGS. 1 through 3, they show a fastening apparatus in accordance with the preferred embodiment of the present invention. The fastening apparatus includes a base member 10, a pivot plate member 20 and a positioning member 30 used for pivotally coupling the base and pivot plate members 10, 20 to each other. The pivot plate member 20 is able to pivot with respect to the base member 10 between a first position and a second position by operating the positioning member 30. Further, by releasing the positioning member 30, the pivot plate member 20 is fixed to the base member 10 in position.

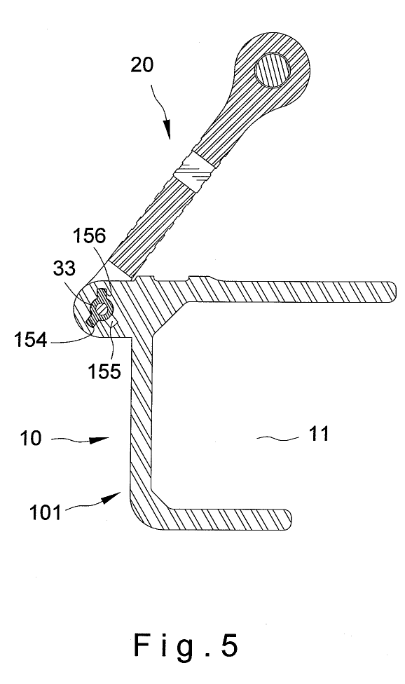

The base member 10, which has first and second ends 101, 102, includes a U-shaped receptacle 11 formed at the first end 101 and a restricting element 12 threading through the bottom side of the receptacle 11. The receptacle 11 is adapted to be inserted by an edge of a truck, and the restricting element 12 is able to tightly abut against the bottom of the edge of the truck so that a cooperation of the receptacle 11 and the restricting element 12 is used to fix the fastening apparatus to the truck. A tie portion 13 is integrally formed on the second end 102 and a rope is able to tie at the tie portion 13. A pivotal portion 14 projects from a lateral side of the base member 10 between the first and second ends 101, 102. A positioning hole 15 pierces through the pivotal portion 14 longitudinally and includes a first section 151, a second section 152 and an annular groove 153 transversely defined therethrough between the first and second sections 151, 152 and communicating with positioning hole 15. A piece 16 is adapted to insert into the annular groove 153. First, second and third radial position portions 154, 155, 156 are defined in the second section 152 (shown in FIG. 5). A cross-section of the second section 152 of the positioning hole 15 is a circle with three radial slots and the slots are not in the same radial position.

The pivot plate member 20, which has first and second ends 201, 202, includes a receiving recess 21 and first and second positioning openings 22, 23. The receiving recess 21 is adapted to receive the pivotal portion 14 so that the pivot plate member 20 is able to pivot with respect to the pivotal portion 14. The first and second positioning openings 22, 23 respectively correspond to the positioning hole 15. A through-hole 24 pierces through the second end 202 longitudinally. A fastening member 25 is inserted through the through-hole 24 and includes a handle 251 defined at an end thereof and a threaded portion 252 formed on the outer periphery of another end thereof. After the fastening member 25 is inserted into the through-hole 24, the second end 202 of the pivot plate member 20 is sandwiched by the handle 251 and the threaded portion 252. A locking member 26, then, is engaged with the threaded portion 252.

The positioning member 30 includes a shaft 31, an elastic element 32 disposed in the first positioning opening 22 and a positioning element 33 disposed in the second positioning opening 23. A pressing end 311 and a coupled end 312 are respectively formed at two ends of the shaft 31. The shaft 31 is inserted through the elastic element 32, the first positioning opening 22, the first section 151 of the positioning hole 15, the piece 16, the second section 152 of the positioning hole 15 and the second positioning opening 23 in sequence. The coupled end 312 has outer threads and the positioning element 33 has inner threads so that the coupled end 312 is able to insert to and engage with the positioning element 33. The piece 16 prevents the positioning element 33 detaching from the positioning hole 15 toward the first section 151. A cross-section of the positioning element 33 is equal to the second positioning opening 23 and non-circle. First and second radial projecting portions 331, 332 are formed on the outer periphery of the positioning element 33 radially.

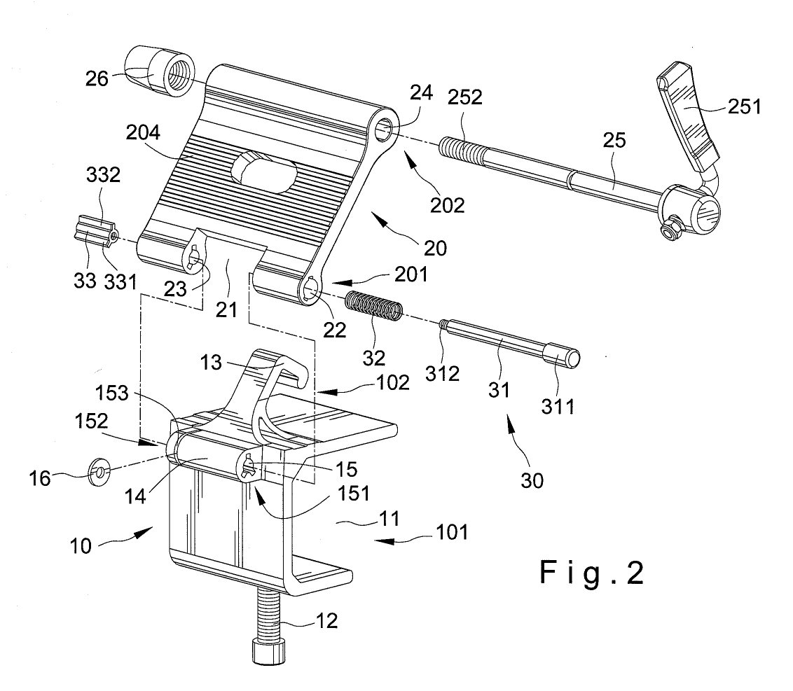

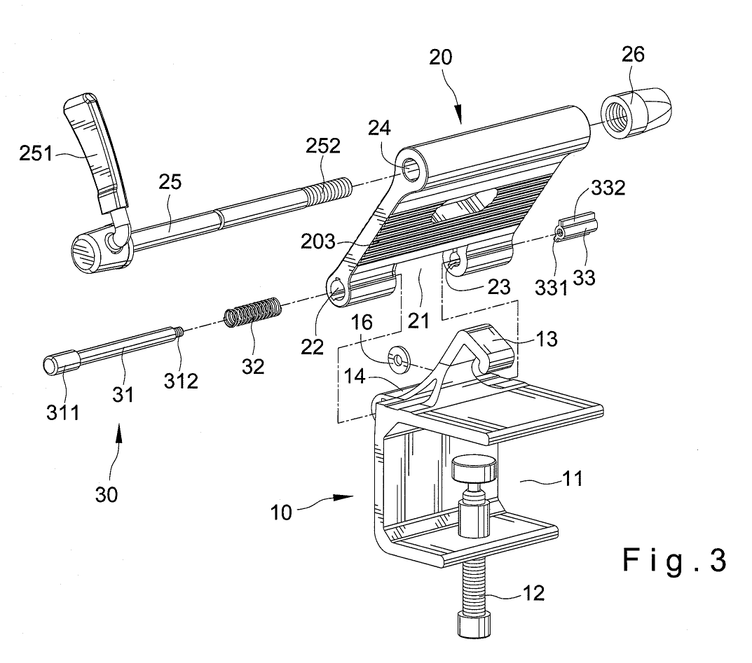

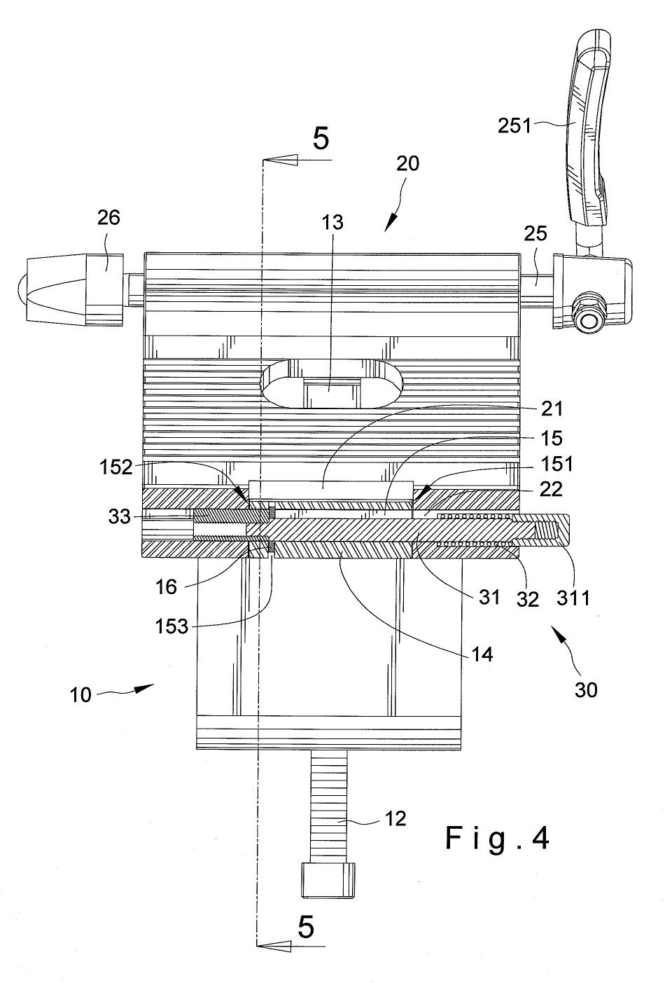

Referring to FIGS. 4 and 5, while the pivot plate member 20 is in the first position, a first surface 203 (shown in FIGS. 2 and 3) of the pivot plate member 20 abuts with the tie portion 13 of the base member 10 and the positioning element 33 is restricted in both of the second positioning opening 23 and the positioning hole 15. In the same time, the first and second radial projecting portion 331, 332 are respectively positioned in the first and third radial position portions 154, 156 of the positioning hole 15 as to prevent the pivot plate member 20 pivoting with respect to the base member 10.

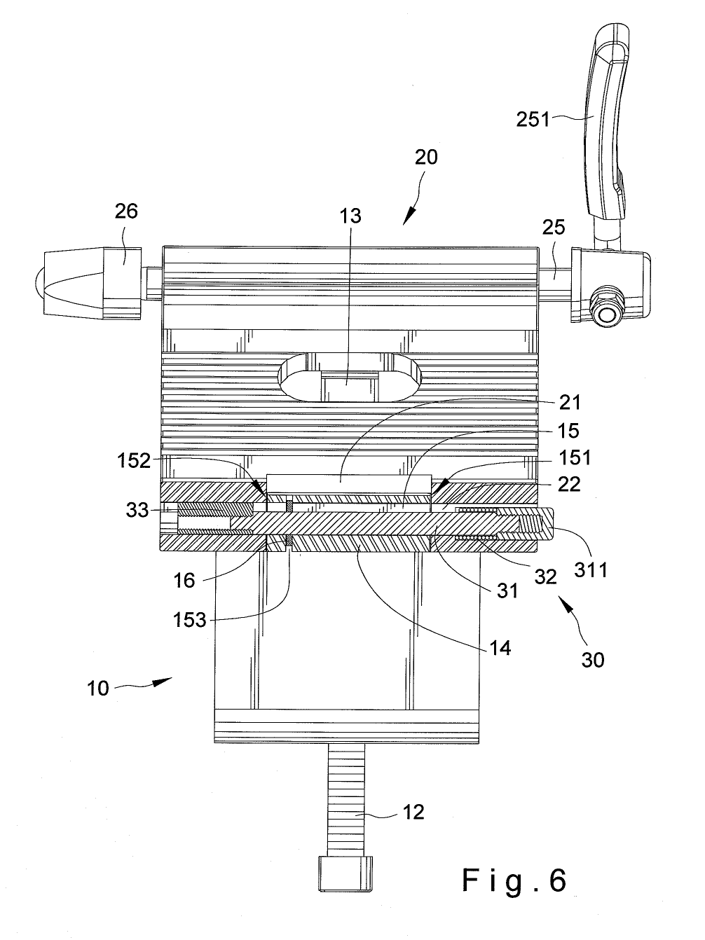

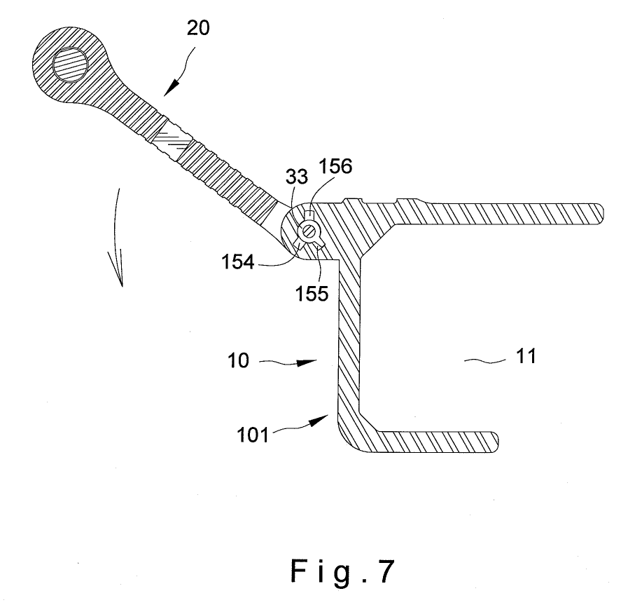

Referring to FIGS. 6 and 7, after pushing the pressing end 311 of the shaft 31 toward the pivot plate member 20, the elastic element 32 is pressed and then, the positioning element 33 is driven to detach the positioning hole 15 from the second section 152. Hence, the pivot plate member 20 enables to pivot with respect to the base member 10.

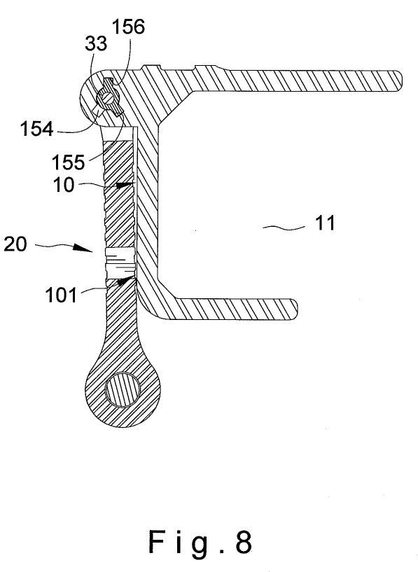

Further referring to FIG. 8, while the pivot plate member 20 is in the second position, a second surface 204 (shown in FIGS. 2 and 3) of the pivot plate member 20 abuts with the outer wall of the receptacle 11 of the base member 10 as to remove restriction of the positioning member 30 about the pivot plate member 20. The elastic element 32 is released and the shaft 31 drives the positioning element 33 to move toward the pivotal portion 14. And the positioning element 33 is restricted in both of the second positioning opening 23 and the positioning hole 15. In the same time, the first and second radial projecting portions 331, 332 are respectively positioned in the third and second radial position portions 156, 155 of the positioning hole 15 as to prevent the pivot plate member 20 pivoting with respect to the base member 10.

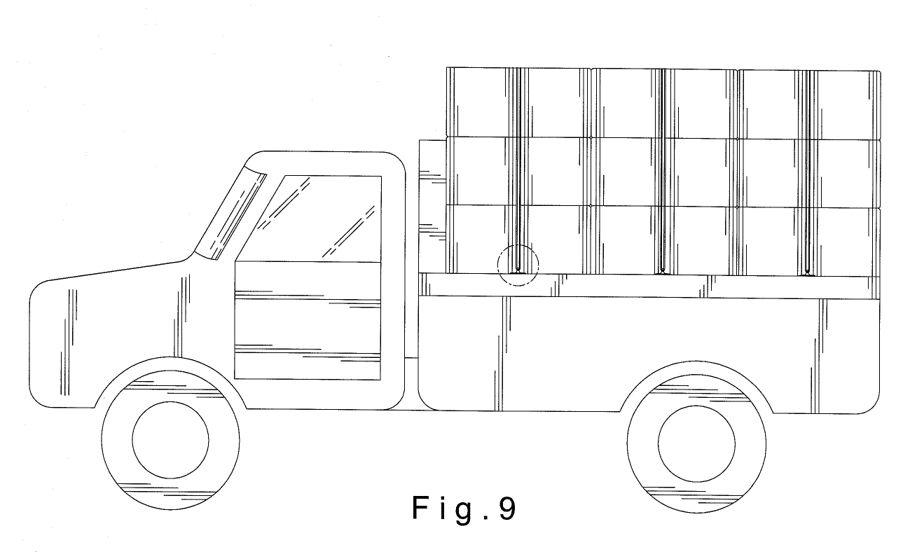

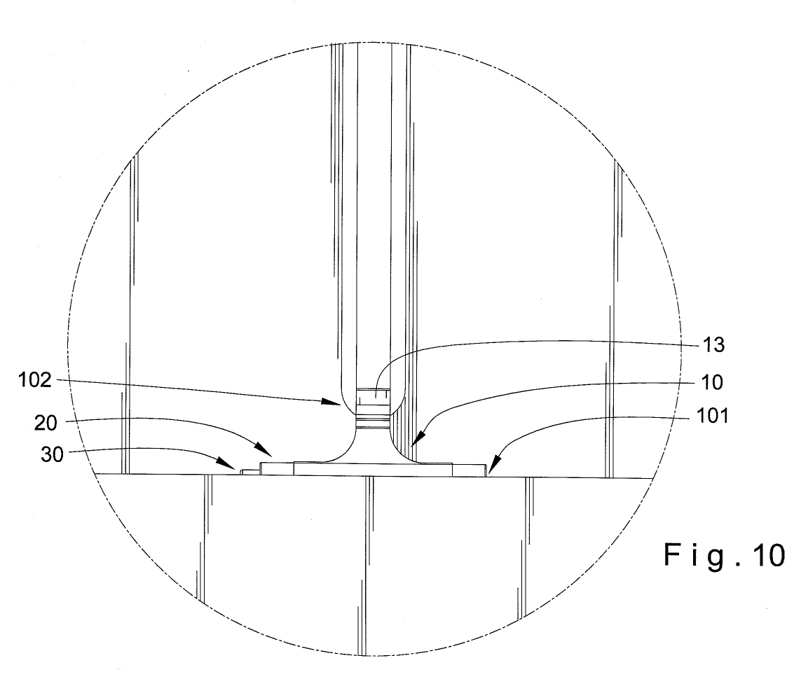

The fastening apparatus is able to tie goods to a truck as shown in FIGS. 9 and 10. After operating the positioning member 30, the pivot plate member 20 is in the second position. The receptacle 11 is adapted to fasten to the truck and a rope used for tying goods ties onto the tie portion 13 of the base member 10.

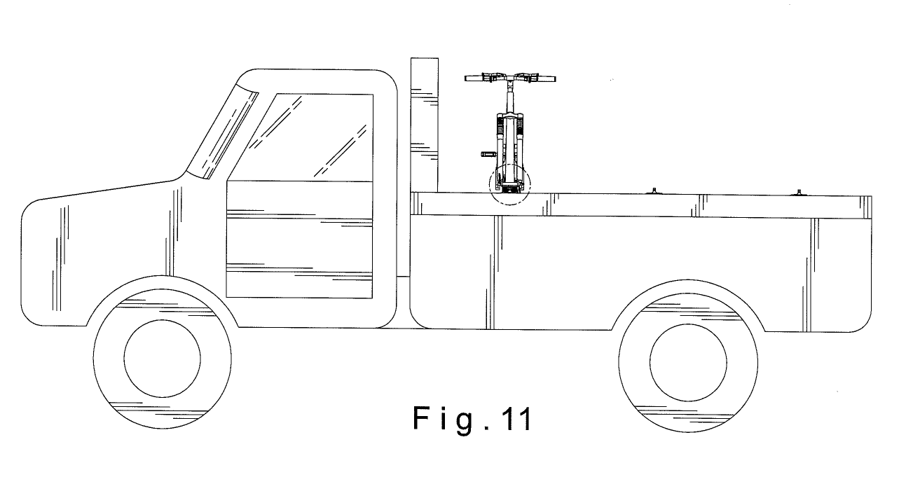

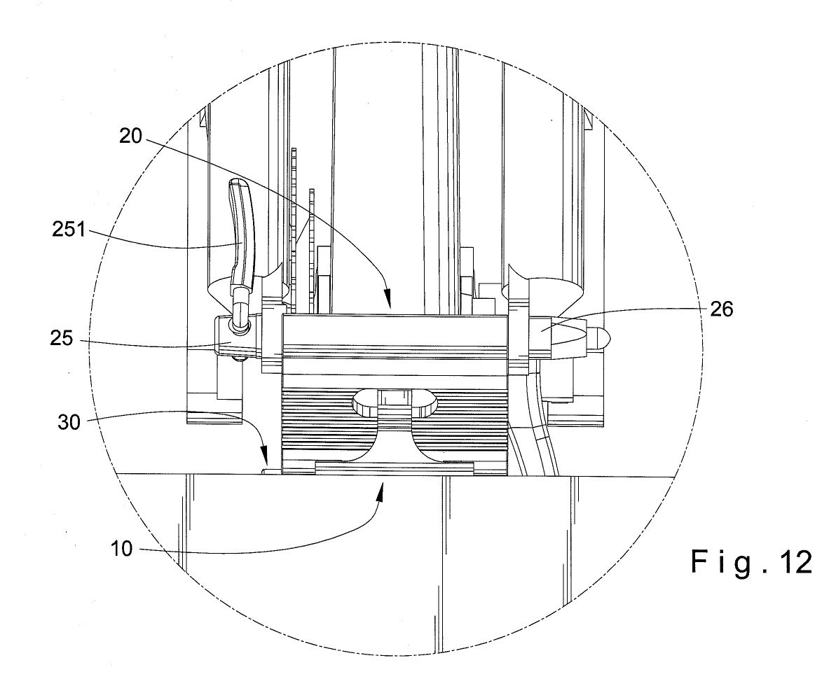

The fastening apparatus is able to fasten a bicycle to a truck as shown in FIGS. 11 and 12. After operating the positioning member 30, the pivot plate member 20 is in the first position. The receptacle 11 is adapted to fasten to the truck and then, after detaching the locking member 26 from the fastening member 25 and removing the fastening member 25 from the through-hole 24, a front fork of the bicycle is disposed at the pivot plate member 20 and the fastening member 25 is adapted to insert through the front fork and the through-hole 24 and engage with the locking member 26 again. Hence, the bicycle can be fixed to the fastening apparatus by engagement of the front fork, the locking member 26 and the fastening member 25.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A detachable fastening apparatus comprising:
a base member including a first end adapted for coupling to a truck and a second end being able to be tied by a rope; and
a pivot plate member, which is moveable between a first position and a second position, pivotally coupled to the base member between the first and second ends of the base member and selectively positioned in the first position or the second position via a positioning member.

2. The detachable fastening apparatus as claimed in claim 1 wherein the base member includes a pivotal portion projecting therefrom for pivotally coupling to the pivot plate member and a positioning hole piercing through the pivotal portion; wherein the pivot plate member, which has first and second ends, includes first and second positioning openings at the first end thereof, with the positioning member provided to insert through the first positioning opening, the positioning hole and the second positioning opening in sequence.

3. The detachable fastening apparatus as claimed in claim 2 wherein the positioning member includes a shaft, an elastic element disposed in the first positioning opening and a positioning element; wherein while the positioning element is restricted in both of the second positioning opening and the positioning hole, the pivot plate member is fixed with respect to the base member; wherein while the positioning element is detached from the positioning hole, the pivot plate member is able to pivot with respect to the base member.

4. The detachable fastening apparatus as claimed in claim 3 wherein the positioning hole includes a first section, a second section and an annular groove transversely defined therethrough between the first and second sections and communicating with positioning hole, with a piece adapted to insert into the annular groove for preventing the positioning element detaching the positioning hole from the first section.

5. The detachable fastening apparatus as claimed in claim 4 further comprising first, second and third radial position portions defined in the second section of the positioning hole and first and second radial projecting portions formed on the outer periphery of the positioning element radially; wherein while the pivot plate member is in the first position, the first and second radial projecting portion are respectively positioned in the first and third radial position portions; wherein while the pivot plate member is in the second position, the first and second radial projecting portions are respectively positioned in the third and second radial position portions of the positioning hole.

6. The detachable fastening apparatus as claimed in claim 3, with a cross-section of the positioning element equal to the second positioning opening and non-circle.

7. The detachable fastening apparatus as claimed in claim 1 wherein the base member includes a receptacle formed at the first end thereof and a restricting element threading through a bottom side of the receptacle; wherein the receptacle is adapted to be inserted by an edge of a truck, and the restricting element is able to tightly abut against the bottom of the edge of the truck so that a cooperation of the receptacle and the restricting element is used to fix the fastening apparatus to the truck.

8. The detachable fastening apparatus as claimed in claim 1 further comprising a tie portion 13 provided on the second end of the base member, with the rope is able to tie at the tie portion.

9. The detachable fastening apparatus as claimed in claim 8, with the tie portion integrally formed from the base member.

10. The detachable fastening apparatus as claimed in claim 1 wherein the pivot plate member includes a first end pivotally coupled to the base member and a second end, with a fastening member and a locking member installed to the second end of the pivot plate member; wherein a bicycle can be fixed to the fastening apparatus by engagement of a front fork of the bicycle, the locking member and the fastening member.

11. The detachable fastening apparatus as claimed in claim 8 wherein while the pivot plate member is in the first position, a first surface of the pivot plate member abuts with the tie portion of the base member.

12. The detachable fastening apparatus as claimed in claim 7 wherein while the pivot plate member is in the second position, a second surface of the pivot plate member abuts with an outer wall of the receptacle of the base member.
